(19) United States
(12) Patent Application Publication
(10) Pub. No.: US 2026/0167491 A1
(43) Pub. Date: Jun. 18, 2026

(54) PURIFICATION OF HYDROGEN REMOVED FROM STORAGE

(71) Applicant: UOP LLC, Rosemont, IL (US)

(72) Inventors: Rajasi Shukre, Bloomingdale, IL (US); Shubhra J. Bhadra, Naperville, MI (US); Eleftherios Adamopoulos, Gurnee, IL (US); Bradley P. Russell, Longmont, CO (US)

(21) Appl. No.: 19/418,006

(22) Filed: Dec. 12, 2025

Related U.S. Application Data
(60) Provisional application No. 63/733,350, filed on Dec. 12, 2024.

(51) Int. Cl. C01B 3/508

(52) U.S. Cl. CPC C01B 3/508; C01B 2210/001

(57) ABSTRACT

A process for recovery of hydrogen from underground storage is provided. The process involves sending a hydrogen stream stored in an underground cavern, a depleted gas field or a saline aquifer to a pressure swing adsorption unit and then to a membrane unit to produce hydrogen having a purity of above 99.5 mol %.

### FIELD OF THE INVENTION

This invention generally relates to a process for maximizing hydrogen recovery especially from storage.

### BACKGROUND

Interest has increased into the use of renewable sources such as wind, solar and hydro energy to produce electricity. However, the fluctuating nature of electricity produced from such sources requires a bulk energy storage system to store energy as a buffer and to allow for demand to be met constantly. Hydrogen may be stored in a number of different ways including underground salt caverns, depleted gas fields and aquifers. Underground storage of hydrogen is becoming a proven way to store a huge amount of energy underground after hydrogen has been produced since hydrogen has a higher energy content per unit mass than other gases such as methane and natural gas. The hydrogen may be stored underground in depleted hydrocarbon reservoirs, aquifers and manmade underground cavities such as salt caverns. The hydrogen may mix with impurities during storage or there may be other gases that are present as having been added to the hydrogen gas for other purposes. It is necessary to be able to recover the hydrogen and to purify the gas to the specified level depending upon the end use.

### BRIEF SUMMARY

A process is provided for the purification of a hydrogen-rich stream that has been kept in underground storage facilities such as salt caverns, depleted hydrocarbon reservoirs or aquifers. The feed purity of the hydrogen stream from the storage facility can range from about 50 to 99 mol % or greater. The other contaminants in the feed can consist of hydrocarbons such as methane, ethane, propane and C4+ components, nitrogen, carbon dioxide, argon, water and hydrogen sulfide. The hydrogen product purity obtained from the purification process can range from 99.5 mol % (industrial grade) to 99.97 mol % (fuel cell grade). The purification is done by a combination of a pressure swing adsorption unit and a membrane unit. The stored gas after a pressure reduction step and optionally a pretreatment step (for example, to remove H₂S and C9+ hydrocarbons) is divided into a first portion and a second portion. The second portion is passed to a pressure swing adsorption unit to produce a purified hydrogen product gas and a low-pressure tail gas stream. The tail gas is compressed and mixed with the first portion and sent to a hydrogen permeable membrane unit. The permeate is compressed and mixed with the second portion. The membrane residue gas can be sent to a natural gas pipeline, re-injected in the reservoir, or used as fuel gas in the process. The purified hydrogen product gas is sent to the required destination such as a hydrogen pipeline.

### BRIEF DESCRIPTION OF THE DRAWINGS

FIG. 1 shows a flow scheme used to produce a purified hydrogen product stream from a stream of hydrogen gas that has been stored underground.

### DEFINITIONS

As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, carbon oxides, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules. Furthermore, a superscript “+” or “−” may be used with an abbreviated one or more hydrocarbons notation, e.g., C3⁺ or C3⁻, which is inclusive of the abbreviated one or more hydrocarbons. As an example, the abbreviation “C3⁺” means one or more hydrocarbon molecules of three carbon atoms and/or more. A “stream” may also be or include substances, e.g., fluids or substances behaving as fluids, other than hydrocarbons, such as air, hydrogen, or catalyst.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “rich” can mean an amount of at least generally about 50%, and preferably about 70%, by mole, of a compound or class of compounds in a stream.

As used herein, the term “substantially” can mean an amount of at least generally about 80%, preferably about 90%, and optimally about 99%, by mole, of a compound or class of compounds in a stream.

As used herein, the terms “adsorbent” and “adsorber” include, respectively, an absorbent and an absorber, and relates, but is not limited to, adsorption, and/or absorption.

As used herein, the term “hour” may be abbreviated “hr”, the term “kilogram” may be abbreviated “kg”, the term “kilopascal” may be abbreviated “KPa”, and the terms “degrees Celsius” may be abbreviated “° C.”. All pressures are absolute.

As depicted, process flow lines in the figures can be referred to interchangeably as, e.g., lines, pipes, feeds, effluents, products, portions, remainders, discharges, or streams.

### DETAILED DESCRIPTION

The present disclosure is directed to a process for the purification of hydrogen rich stream sourced from underground storage facilities such as depleted gas fields, aquifers and salt caverns. The feed purity of the hydrogen stream from the storage facility can range from 50 mol % to 99 mol % or greater. The other contaminants in the feed can consist of hydrocarbons such as methane, ethane, propane and C4+ components, nitrogen, carbon dioxide, argon, water, and hydrogen sulfide. The hydrogen product purity obtained from the purification process can range from 99.5 mol % (industrial grade) to 99.97 mol % (fuel cell grade). The flow schemes employed consist of two purification blocks, which operate continuously. The first block is a pressure-swing adsorption unit. The effluent stream/tail gas of the pressure swing adsorption system contains hydrogen ranging from about 25 mol % to 75 mol %. This stream is compressed and is fed to the second purification block which consists of a membrane unit, which can have multiple membrane modules, such as 2 to 100 or more membrane modules. The membrane type can be a hollow fiber or a spiral wound membrane, which is selective to hydrogen. Thus, the permeate stream is a higher purity hydrogen stream compared to the membrane feed stream. The low pressure permeate stream is compressed and mixed with a portion of the inlet gas from the storage facility. A first portion of the inlet gas from the storage facility bypasses the PSA unit and is mixed with the compressed tail gas from the PSA unit. The mixed stream is fed to the membrane unit. The process parameters of the configuration can be optimized to achieve a net hydrogen recovery of about 90% to 99%+ with respect to the underground storage feed gas, for the range of the specified feed conditions. The first and second portions of the inlet gas from the storage reservoir can each vary from 0 to 100% and will be chosen based primarily on the inlet gas composition. These fractions can vary during operation of the purification system as the inlet gas composition changes with time. For example, at the beginning of an annual production cycle of 3 months the inlet gas may comprise 90 to 95 mol % hydrogen and the first portion may be 0% to 20% for several days. As the production cycle continues, the inlet gas may become increasingly contaminated (with natural gas components including methane) and drop to 50 or 60 mol % hydrogen by the end of the production cycle. In order to accommodate the higher impurity load, the first portion is increased over time and the second portion is correspondingly decreased. The first portion may increase to 70% to 100% by the end of the production cycle. Membrane modules are taken offline or brought online as required to manage the increasing and decreasing membrane flow rate and impurity load.

The feed pressure to the pressure swing adsorption unit may range up to 60 or 70 bara. The operating temperature of the PSA unit may range from about 20° C. to 60° C. in the present application. A portion of the feed from the underground storage facility is mixed with a permeate stream of a downstream membrane purification system and the resulting mixed stream is fed to the PSA unit. The PSA tail gas pressure can range from 1 bara to 3 bara. Each PSA adsorber vessel may have one or more adsorbent layers such as activated alumina, silica gel, activated carbon with a top layer of a molecular sieve.

Suitable adsorbents can include one or more crystalline molecular sieves, activated carbons, activated clays, silica gels, activated aluminas, and combinations thereof. Preferably, the adsorbents are one or more of an activated carbon, an alumina, an activated alumina, a silica gel and a molecular sieve. An exemplary PSA zone is disclosed in, e.g., U.S. Pat. No. 5,332,492.

The second part of the purification system is a membrane-based separation system, wherein the membrane unit can be a hollow-fiber or a spiral wound membrane. The hollow fiber membrane can be made of at least one of a polyimide, cellulose acetate, cellulose triacetate, and polysulfone. Typically, the polyimide may be formed by reacting a dianhydride and a diamine or a dianhydride and a diisocyanate. Such membranes are disclosed in, e.g., U.S. Pat. No. 4,863,492. The feed to the membrane unit is the compressed tail gas from the PSA unit and a first portion of the inlet gas from the hydrogen storage reservoir. The hydrogen content of the membrane feed can range from 40 mol % hydrogen to 90 mol % hydrogen, depending on the feed composition and operating conditions of the PSA unit. The membrane unit is selective to hydrogen and the low pressure permeate stream from the membrane unit is compressed to the feed pressure of the PSA unit, after which it is mixed with a portion of the feed gas from the underground storage facility. The hydrogen content of the permeate stream varies between 90 mol % to 99 mol %, depending on the tail gas conditions of the PSA unit and the inlet gas composition. The non-permeate stream may go to a natural gas pipeline, a fuel gas header, or may be re-injected into the reservoir. The once-through hydrogen recovery from the PSA can range from about 85%-95%. The membrane hydrogen recovery can range from about 85%-95%. The overall hydrogen recovery that can be achieved through this configuration can range from about 90 to 99%+ for all the specified variations in feed and PSA operating conditions.

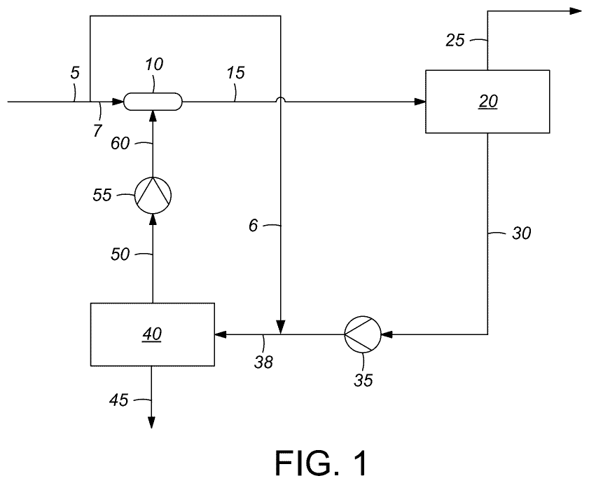

FIG. 1 shows a flow scheme used to purify hydrogen stored underground, such as in a cavern. Cavern gas 5 is divided into a first portion 6 and a second portion 7. The second portion 7 is mixed with compressed membrane permeate stream 60 and then as a feed 15 to pressure swing adsorption unit 20 that may contain six or more pressure swing adsorption beds with purified hydrogen product 25 that is sent to be used. A pressure swing adsorption (PSA) tail gas stream 30 is sent through compressor 35 to produce compressed tail gas stream 38 that is mixed with a first portion 6 of inlet hydrogen gas and is then sent to a membrane unit 40. The permeate 50 is compressed by compressor 55 to produce compressed permeate stream 60 that is then combined with a second portion 7 of the inlet hydrogen stream 5. A retentate stream 45 may be sent to a natural gas pipeline, may be re-injected into the reservoir or may be used as fuel gas.

### EXAMPLES

In Examples 1-4, temperatures and pressures were determined for PSA tail gas pressure at two different pressures for both hydrogen purification to fuel gas grade of 99.97 mol % (Examples 1 and 2) and at industrial grade 99.5 mol % (Examples 3 and 4).

### Example 1

In Example 1, cavern gas 5 is 99.76 mol % hydrogen at 57° C. and 60 bara and feed 15 is at 57° C. and 60 bara. Purified hydrogen product 25 is at 62° C. and 59.31 bara. PSA tail gas stream is at 47° C. and 4.5 bara and after compression compressed tail gas stream is at 80° C. and 13 bara. The permeate 50 is at 80° C. and 5.9 bara and then the compressed permeate stream after compression compressed permeate stream is at 57° C. and 60 bara. Retenate stream 45 is at 80° C. and 12 bara.

### Example 2

In Example 2, cavern gas 5 is 99.76 mol % hydrogen at 57° C. and 60 bara and feed 15 is at 57° C. and 60 bara. Purified hydrogen product 25 is at 62° C. and 59.31 bara. PSA tail gas stream is at 47° C. and 1.3 bara and after compression compressed tail gas stream is at 74° C. and 13.15 bara. The permeate 50 is at 74° C. and 5.9 bara and then the compressed permeate stream after compression compressed permeate stream is at 57° C. and 60 bara. Retenate stream 45 is at 80° C. and 12 bara.

### Example 3

In Example 3, cavern gas 5 is 97.76 mol % hydrogen at 57° C. and 60 bara and feed 15 is at 57° C. and 60 bara. Purified hydrogen product 25 is at 62° C. and 59.3 bara. PSA tail gas stream is at 47° C. and 4.5 bara and after compression compressed tail gas stream is at 77° C. and 13.8 bara. The permeate 50 is at 77° C. and 4.8 bara and then the compressed permeate stream after compression compressed permeate stream is at 57° C. and 60 bara. Retenate stream 45 is at 77° C. and 12 bara.

### Example 4

In Example 4, cavern gas 5 is 97.76 mol % hydrogen at 57° C. and 60 bara and feed 15 is at 57° C. and 60 bara. Purified hydrogen product 25 is at 62° C. and 59.3 bara. PSA tail gas stream is at 47° C. and 1.3 bara and after compression compressed tail gas stream is at 77° C. and 13.8 bara. The permeate 50 is at 77° C. and 4.8 bara and then the compressed permeate stream after compression compressed permeate stream is at 57° C. and 60 bara. Retenate stream 45 is at 77° C. and 12 bara.

Several different configurations of PSA units were compared in their recovery of hydrogen when compared to the combination of PSAs unit and membrane units as shown in Table 2.

TABLE 2

| Configuration | Hydrogen recovery |
|---|---|
| Once through a single PSA unit | ~81% |
| PSA with partial tail gas recycle | ~87% |
| Two-stage PSA with product blending from 2 | ~95.5% |
| PSA units | |
| Two-stage PSA with product recycle | ~96.5% |
| PSA with membrane unit of FIG. 1 | ~99% |

### Example 5

In Example 5, a depleted gas field gas 5 is 56 mol % hydrogen with 40 mol % methane and other contaminants at 20° C. and 60 bara. Inlet gas stream 5 is divided into a first portion 6 comprising 75% of stream 5 and a second portion 7 comprising 25% of stream 5. Purified hydrogen product 25 at 99.5 mol % is at 43° C. and 44 bara. PSA tail gas stream is at 1.4 bara and 31° C. and after compression compressed tail gas stream is at 70° C. and 61 bara. The membrane permeate 50 is at 70° C. and 4.5 bara and then the compressed permeate stream after compression is at 40° C. and 44.5 bara. Retentate stream 45 is at 60 bara and 70° C.

### SPECIFIC EMBODIMENTS

While the following is described in conjunction with specific embodiments, it will be understood that this description is intended to illustrate and not limit the scope of the preceding description and the appended claims.

A first embodiment of the invention is a process for recovery of hydrogen from underground storage comprising obtaining a hydrogen feed stream from an underground storage reservoir wherein the hydrogen is at a pressure from about 100 to 300 bara, dividing the hydrogen feed stream into a first portion and a second portion, mixing the second portion with a compressed permeate stream to produce a mixed second portion, sending the mixed second portion to a pressure swing adsorption unit to produce a product stream comprising a greater percentage of hydrogen than the hydrogen feed stream and a tail gas comprising a lower percentage of hydrogen than the hydrogen feed stream, mixing the first portion with a compressed tail gas stream and sending the first mixed portion to a membrane unit to produce a permeate stream having a higher percentage of hydrogen than the compressed tail gas stream and a retentate gas stream and compressing the permeate stream to mix with the second portion wherein the first portion and the second portion comprise from 0-100% of the hydrogen feed stream. An embodiment of the invention is one, any or all of prior embodiments in this paragraph up through the first embodiment in this paragraph wherein when hydrogen purity of the hydrogen feed stream is low, the first portion will comprise a larger percentage of an inlet gas stream and when hydrogen purity is high, the first portion will comprise a lower percentage of the inlet gas stream. An embodiment of the invention is one, any or all of prior embodiments in this paragraph up through the first embodiment in this paragraph when first portion is 0%. An embodiment of the invention is one, any or all of prior embodiments in this paragraph up through the first embodiment in this paragraph wherein the hydrogen feed stream is at a pressure of about 50-75 bara after the pressure reduction step. An embodiment of the invention is one, any or all of prior embodiments in this paragraph up through the first embodiment in this paragraph wherein the hydrogen feed stream comprises from about 0.5 to 50 mol % methane. An embodiment of the invention is one, any or all of prior embodiments in this paragraph up through the first embodiment in this paragraph wherein the hydrogen feed stream comprises from about 50 mol % to 99 mol % hydrogen. An embodiment of the invention is one, any or all of prior embodiments in this paragraph up through the first embodiment in this paragraph wherein the tail gas has a pressure from about 1.1 to 3 bara. An embodiment of the invention is one, any or all of prior embodiments in this paragraph up through the first embodiment in this paragraph wherein the pressure swing adsorption unit comprises multiple layers of adsorbents selected from activated carbon, silica gel, activated alumina and zeolite molecular sieves. An embodiment of the invention is one, any or all of prior embodiments in this paragraph up through the first embodiment in this paragraph wherein the compressed tail gas stream has a pressure of about 7 bara to at least 95 bara. An embodiment of the invention is one, any or all of prior embodiments in this paragraph up through the first embodiment in this paragraph wherein the compressed tail gas stream comprises from about 25 mol % to about 75 mol % hydrogen. An embodiment of the invention is one, any or all of prior embodiments in this paragraph up through the first embodiment in this paragraph wherein the permeate stream is compressed to match the pressure of the mixed second portion. An embodiment of the invention is one, any or all of prior embodiments in this paragraph up through the first embodiment in this paragraph wherein the permeate stream comprises from about 80 mol % to about 99 mol % hydrogen. An embodiment of the invention is one, any or all of prior embodiments in this paragraph up through the first embodiment in this paragraph wherein the retentate stream is sent to a fuel gas header, power recovery unit, natural gas pipeline, underground storage reservoir, or other site-specific location. An embodiment of the invention is one, any or all of prior embodiments in this paragraph up through the first embodiment in this paragraph wherein a once through the pressure swing adsorption unit of the mixed second portion results in recovery of at least 85% of the hydrogen in pressure swing adsorption unit feed gas. An embodiment of the invention is one, any or all of prior embodiments in this paragraph up through the first embodiment in this paragraph wherein a once through passage of the compressed tail gas and a slip stream of inlet gas through the membrane unit recovers from about 85-99% of the hydrogen into the permeate stream. An embodiment of the invention is one, any or all of prior embodiments in this paragraph up through the first embodiment in this paragraph wherein a once through passage of the compressed tail gas and a slip stream of inlet gas through the membrane unit recovers a permeate stream with about 85 to 99 mol % hydrogen. An embodiment of the invention is one, any or all of prior embodiments in this paragraph up through the first embodiment in this paragraph wherein a once through passage of the compressed tail gas and a slip stream of inlet gas through the membrane unit recovers from about 80 to 98% of the methane into the retentate stream. An embodiment of the invention is one, any or all of prior embodiments in this paragraph up through the first embodiment in this paragraph wherein the process results in about 90% to at least about 99% recovery of the hydrogen from the hydrogen feed stream. An embodiment of the invention is one, any or all of prior embodiments in this paragraph up through the first embodiment in this paragraph wherein the underground storage is a salt cavern, a depleted gas field or a saline aquifer.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for recovery of hydrogen from underground storage comprising obtaining a hydrogen feed stream from an underground storage reservoir wherein said hydrogen is at a pressure from about 100 to 300 bara, dividing said hydrogen feed stream into a first portion and a second portion, mixing the second portion with a compressed permeate stream to produce a mixed second portion, sending the mixed second portion to a pressure swing adsorption unit to produce a product stream comprising a greater percentage of hydrogen than said hydrogen feed stream and a tail gas comprising a lower percentage of hydrogen than said hydrogen feed stream, mixing said first portion with a compressed tail gas stream and sending said first mixed portion to a membrane unit to produce a permeate stream having a higher percentage of hydrogen than said compressed tail gas stream and a retentate gas stream and compressing the permeate stream to mix with the second portion wherein said first portion and said second portion comprise from 0-100% of said hydrogen feed stream.

2. The process of claim 1 wherein when hydrogen purity of said hydrogen feed stream is low, said first portion will comprise a larger percentage of an inlet gas stream and when hydrogen purity is high, the first portion will comprise a lower percentage of the inlet gas stream.

3. The process of claim 1 when first portion is 0%.

4. The process of claim 1 wherein said hydrogen feed stream is at a pressure of about 50-75 bara after the pressure reduction step.

5. The process of claim 1 wherein said hydrogen feed stream comprises from about 0.5 to 50 mol % methane.

6. The process of claim 1 wherein said hydrogen feed stream comprises from about 50 mol % to 99 mol % hydrogen.

7. The process of claim 1 wherein said tail gas has a pressure from about 1.1 to 3 bara.

8. The process of claim 1 wherein said pressure swing adsorption unit comprises multiple layers of adsorbents selected from activated carbon, silica gel, activated alumina and zeolite molecular sieves.

9. The process of claim 1 wherein the compressed tail gas stream has a pressure of about 7 bara to at least 95 bara.

10. The process of claim 9 wherein said compressed tail gas stream comprises from about 25 mol % to about 75 mol % hydrogen.

11. The process of claim 1 wherein said permeate stream is compressed to match the pressure of said mixed second portion.

12. The process of claim 1 wherein said permeate stream comprises from about 80 mol % to about 99 mol % hydrogen.

13. The process of claim 1 wherein said retentate stream is sent to a fuel gas header, power recovery unit, natural gas pipeline, underground storage reservoir, or other site-specific location.

14. The process of claim 1 wherein a once through said pressure swing adsorption unit of said mixed second portion results in recovery of at least 85% of said hydrogen in pressure swing adsorption unit feed gas.

15. The process of claim 1 wherein a once through passage of said compressed tail gas and a slip stream of inlet gas through said membrane unit recovers from about 85-99% of said hydrogen into the permeate stream.

16. The process of claim 1 wherein a once through passage of said compressed tail gas and a slip stream of inlet gas through said membrane unit recovers a permeate stream with about 85 to 99 mol % hydrogen.

17. The process of claim 5 wherein a once through passage of said compressed tail gas and a slip stream of inlet gas through said membrane unit recovers from about 80 to 98% of said methane into the retentate stream.

18. The process of claim 1 wherein said process results in about 90% to at least about 99% recovery of said hydrogen from said hydrogen feed stream.

19. The process of claim 1 wherein said underground storage is a salt cavern, a depleted gas field or a saline aquifer.
